(19) United States
(12) Patent Application Publication
(10) Pub. No.: US 2007/0094131 A1
(43) Pub. Date: Apr. 26, 2007

(54) BAD DEBT RECOVERY SYSTEM AND METHOD IN A PREPAID SERVICES ENVIRONMENT

(75) Inventors: Richard E. Wymore, Clackamas, OR (US); Anthony Splaver, Camas, WA (US)

Correspondence Address: MARGER JOHNSON & MCCOLLOM, P.C., 210 SW MORRISON STREET, SUITE 400, PORTLAND, OR, 97204, US

(73) Assignee: COMMUNICATIONS PRODUCT DEVELOPMENT, INC., Vancouver, WA (US)

(21) Appl. No.: 11/553,418

(22) Filed: Oct. 26, 2006

Related U.S. Application Data
(60) Provisional application No. 60/730,590, filed on Oct. 26, 2005.

(51) Int. Cl. G06Q 40/00

(52) U.S. Cl. 705/39

(57) ABSTRACT

In a system and method for enabling bad debt recovery in a prepaid services environment, a bad debt balance (acquired under a post-paid regime) is stored in a bad debt database associated with the customer who accumulated the bad debt. Deposits by the customer into a pre-paid account are then accepted and the balance tracked in a pre-paid account database. Requests for service by the customer, e.g. pre-paid telephone service, are tracked by the pre-paid application server and the services rendered while debiting the pre-paid service database according to the services used. Such requests for pre-paid service also serve to trigger an automatic withdrawal of an additional amount from the pre-paid account which is then applied to the bad debt balance.

### CROSS REFERENCE TO RELATED APPLICATIONS

This application claims the benefit from U.S. Provisional Patent Application No. 60/730,590 filed Oct. 26, 2005 whose contents are incorporated herein for all purposes.

### BACKGROUND OF THE INVENTION

This invention relates generally to prepaid services and more particularly to a method and apparatus for recovering debt while simultaneously providing services to debtor accounts.

Prepaid services, particularly utilities such as telephone services, have shown a marked increase in popularity over traditional post-paid methods. In a prepaid account, a customer deposits money into an account and is then able to use the services so long as the account shows a positive balance. Once the balance drops to zero, the services are cut off until the customer recharges the account with new funds. The advantages of prepaid accounts over postpaid to the service provider are obvious: such a system eliminates the problem that post-paid systems have with unrecoverable debt from customers who use the services but do not pay the bill at the end of the month.

Post-paid services are still the primary model for providing services to customers. Unfortunately, options for utility companies to recover bad debt from unpaid accounts are very limited and typically result in the service provider not recovering the debt, and the customer being cut off from the service.

Accordingly, the need remains for a better way to both ensure continued customer use of the services as well as providing a means for recovering the debt that had accumulated in the post-paid environment.

### SUMMARY OF THE INVENTION

The invention provides a new way for a company to recover revenue that would be classified as bad debt. This bad debt is typically written off or sent to a debt collection agency, and these methods are expensive and do not allow the company to fully recover the lost revenue.

This invention allows the company to fully recover the bad debt while still providing the customer with services using the bad debt software and computer hardware solution described in this invention. The bad debt software moves the customer to a prepaid account and the prepaid account balance is used to provide ongoing services while a portion of the balance is used to service the bad debt balance. This invention enables recovery of bad debt from customers using bad debt software, a bad debt application server, a bad debt database server, and other application servers, which significantly improve upon existing methods of collecting bad debt or writing the bad debt off. The bad debt software also eliminates risk of more bad debts by automatically converting a customer to a prepaid regime and automatically recovering the bad debt from the prepaid account balance.

The invention teaches methods that enable continued use of a paid service by a customer from a service provider. In a preferred implementation of this method, a customer debt balance is accumulated from past service use into a post-paid debt account so that the customer debt balance is stored in a bad debt account database. The customer is then allowed to deposit pre-paid funds into a pre-paid account associated with the customer where a pre-paid account balance of said pre-paid funds is stored in a pre-paid database. The customer is then allowed continued use of services associated with the pre-paid funds. The method then operates to withdraw from the pre-paid balance an amount reflective of the services used by the customer. A triggering event associated with use by the customer of the pre-paid service is detected, an additional amount is then withdrawn from the pre-paid balance responsive to the detected triggering event, and the additional amount withdrawn is then applied to the customer debt balance stored in the bad debt account database. Finally, the pre-paid account balance and customer debt balance is reconciled with the amount withdrawn and additional amount withdrawn responsive to use by the customer of the services associated with the pre-paid funds.

The invention further comprises methods for transferring a customer from post-paid to pre-paid services in which a customer is allowed to use services under a post-paid regime, accumulate a customer debt balance, where the customer balance is stored in a debt database from such use. Responsive to a debt trigger event such as the balance being overdue for longer than two months, the customer is prevented from using the services under the post-paid regime. The customer is then transferred to a pre-paid regime. Pre-paid funds and then accepted from the customer and stored into a pre-paid account. The customer is then allowed to use services only under the pre-paid regime so long as the pre-paid account shows a positive balance. Responsive to use under the pre-paid regime, funds are withdrawn from the pre-paid account including an additional amount where the additional amount is applied to the customer debt balance to lower the amount remaining.

The invention furthermore teaches a bad debt recovery system comprising a bad debt application server coupled over a network to at least one service server. A bad debt database server is coupled in communication with the bad debt application server and adapted to store for each bad debt customer account a bad debt balance and a pre-paid balance. Finally, bad debt software is loaded on the bad debt application server and is operable to detect customer activity and move a customer from a postpaid account to a pre-paid account responsive to trigger criteria detected by the bad debt software. The software is also enabled to transfer balances between the pre-paid account balance and the bad debt account balance responsive to activity by the bad debt customer with the pre-paid account.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a schematic diagram of the service and debt tracking network implemented according to a preferred embodiment of the invention.

FIG. 2 is a flow diagram of a process implemented by bad debt software to evaluate if a customer with delinquent payments should be moved to a prepaid bad debt account according to another aspect of the invention.

FIG. 3 is a flow diagram showing a preferred method of operation of the invention to recover bad debt.

### DETAILED DESCRIPTION

This invention provides a solution for recovering bad debt from customers with delinquent bills using bad debt computer software and hardware as herein described. The invention is particularly applicable to companies that provide utility services to customers, like telephony, fax, VOIP, electricity, water, power, ISP, Internet kiosk, web services, or other services. This invention uses software, computers, database servers, application servers, internet servers, telephony servers, and networking hardware to implement the solution.

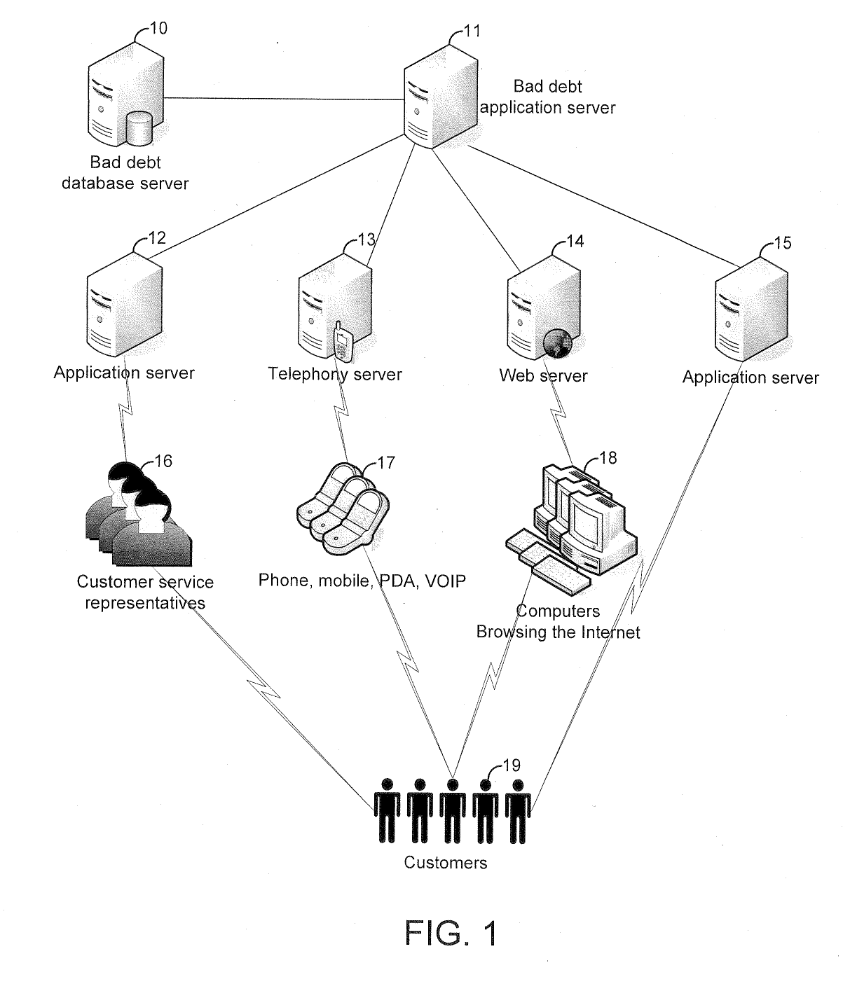

According to a preferred implementation of the invention, a centralized bad debt application server 11 (FIG. 1) is used to provide a single access point for all communications to support the bad debt invention. This invention allows companies to recover bad debt for services by moving customers from postpaid accounts to prepaid accounts using the automatic logic in the bad debt software. The bad debt software and hardware provide the logic to automatically determine when a customer should be moved from a postpaid account to a prepaid account. The prepaid account keeps track of the prepaid account balance that is used for services and the bad debt balance which contains the total amount of the delinquent bills. The prepaid account balance is used to lower the bad debt balance based upon triggering activities occurring within the pre-paid account. Accordingly, this regime allows the company to recover the bad debt while still providing services to the customer on a prepaid basis. The bad debt software eliminates the risk of more bad debt, enables a new revenue stream (because a delinquent customer normally has his service terminate), and provides a way for the customer to still receive the company's services. The bad debt software runs on the bad debt application server.

FIG. 1 shows the block diagram of the hardware elements required for a preferred embodiment of this invention. The bad debt application server 11 in FIG. 1 provides a centralized access point to the back-end bad debt database server 10. The bad debt software runs on the bad debt application server. The bad debt database server 10 stores the prepaid account information including the prepaid account balance and bad debt balance in a persistent database. The database also stores other attributes for the prepaid account and other service related features. The bad debt application server 11 is connected via a network to other application servers and services, and provides a layer of isolation and security. It is understood, however, that the applications can reside on a single server or several servers mounted in rack configuration depending upon desired redundancy practices.

The bad debt will be recovered automatically during triggering transactions, e.g. (a) when the bad debt software converts the customer to a prepaid account, (b) when the prepaid account is used for a service, (c) when a scheduled event occurs (like a monthly surcharge), (d) when the prepaid account is recharged, or (e) during other events for the service occurs. Specific examples of when these events can occur when the customer 19 in FIG. 1 talks with a customer service representative 16, or when the customer 19 uses a telephony service (phone, cell, PDA, VOIP, fax, etc.) 17 which interfaces with the telephony server 13, or when the customer 19 uses his computer to browse the Internet and uses services provided by the web server 14, or when the customer 19 interacts with a service specific application server 15. All such events can also be referred to as trigger events or transactions.

The middle tier of servers (12, 13, 14, and 15) all interface with the bad debt application server 11, which provides the secured centralized access point to the bad debt database server 10. When the events that trigger bad debt recovery occur, the middle tier application servers interface with the bad debt application server 11 to lower the bad debt balance by transferring balance from the prepaid balance. The bad debt software provides the automatic logic to transfer balances between the prepaid account balance and the bad debt balance. The bad debt software provides the logic to automatically determine when to move a customer from a postpaid account to a prepaid account via particular trigger events, e.g. when the credit score of a customer drops below a certain amount, when the balance rises above a certain amount, when monthly payment is not received after a warning has been sent out, etc.

Not shown in FIG. 1 is a post-paid accounting system. These are typically maintained on the service provider's post-paid billing system. Responsive to certain triggering events discussed further below, the post-paid account would be deactivated on the post-paid system and reactivated on the prepaid system. The account number used for the pre-paid system may be the same or different from that of the post-paid system. The account on the prepaid system is designated a bad debt account by populating the bad debt balance field with a monetary value.

In an example of operation, a pre-paid customer 19 would make a long distance telephone call. The call information would be sent to the telephony server 17. The telephony server 17 would request data specifics on this user from the bad debt database server 10. Responsive to this request, the bad debt database server 10 would return information reflecting the deductions applied to the pre-paid customer account for the additional amounts required to pay off a portion of the bad debt. Further information would include the type of calls that the customer 19 can make. This data is passed back to the telephony server 17. If all the data for the customer 19 is positive (i.e. not an inactive account, enough balance, etc.), then the telephony server allows the call to pass through. The data transfer is normally completed over a TCP/IP link but can be any type of data link.

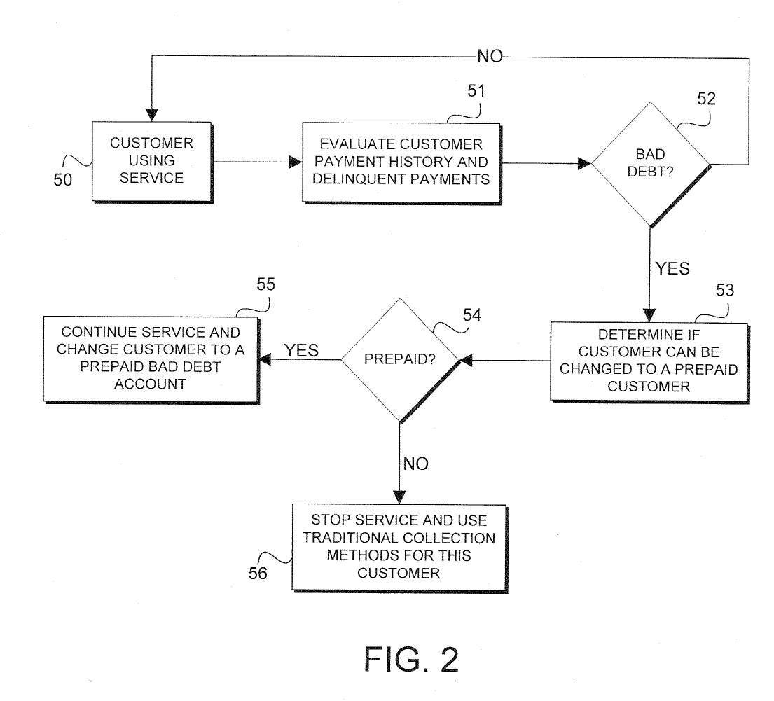

FIG. 2 shows an exemplary flow diagram of the bad debt software when used to evaluate if a customer with delinquent payments should be moved to a prepaid bad debt account. The customer 50 in FIG. 2 is using a service offered by the company. In step 51 the bad debt software running on the bad debt application server 11 in FIG. 1 will evaluate the risk factors for the customer and the history and delinquent bills for the customer. These bad debt triggering events may be automatically detected using logic stored within the post-paid accounting system, or such accounts may be manually selected for transfer to a pre-paid regime according to set criteria. For instance, the system could detect and ‘event’, compare the event to a list of possible triggering events stored in memory, and if in the list then create the pre-paid account, enact a balance transfer, send out a letter, etc. Examples of bad debt triggering events include the following: 5 late payments over a 12 month period, no payments for 2 months, the credit score drops below some threshold amount, etc. The actual criteria used could be selected or determined by the service provider using the invention. The system could look up the actual credit score assigned to the customer, or alternately analyze the payment history and come up with a close approximation of the credit score based on this information. Upon detecting the triggering event, the post-paid system would “trigger” or send an activation notice to the pre-paid system and transfer the amount owning within a bad debt data field.

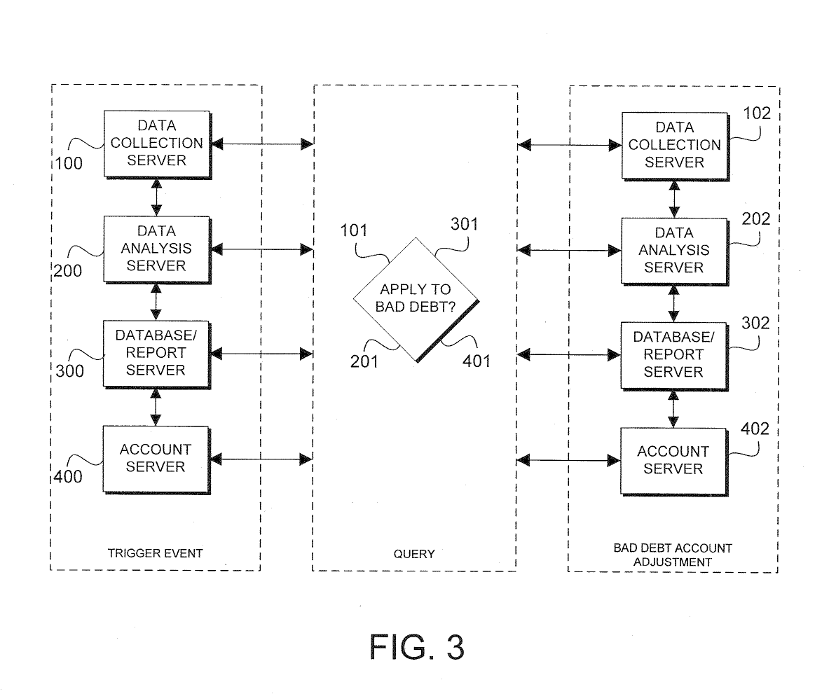

In step 52 of the FIG. 2 flow diagram, the evaluation from step 51 is used by the bad debt software to determine if there is any recoverable bad debt, if there is bad debt then the flow continues to step 53, otherwise the next customer is evaluated in step 50. In step 53 the bad debt software will automatically evaluate if the customer can be changed from a postpaid customer to a prepaid customer. In step 54 if the bad debt software determines the account can be converted to a prepaid bad debt account, then the flow continues to step 55, otherwise the flow continues to step 56. If the customer is converted to a prepaid bad debt account by the software, then the service is continued and the bad debt is automatically recovered in step 55. The bad debt is recovered by the bad debt software using one of the methods in FIG. 3. If the customer cannot be converted to a prepaid customer in step 54, then the service is stopped and traditional collection methods are used in step 56. The bad debt software uses risk assessment logic, evaluation of the customer's payment history, and delinquent bills to determine if the account should be converted to a prepaid account.

FIG. 3 shows the flow diagram of the bad debt software to recover the bad debt. Step 100 in FIG. 3 occurs when the bad debt software converts a postpaid customer to a prepaid customer in step 55 of FIG. 2. When this occurs the customer must make an initial deposit of money to continue using the service of the company. This initial deposit is placed in the prepaid account balance, and the amount of bad debt is placed in the bad debt balance. These balances and other account information and configuration information are stored in the bad debt database server 10 in FIG. 1. In step 101 the configuration settings in the bad debt software will determine if some of the prepaid balance should be applied towards the bad debt balance, and the flow continues to step 102 if the criteria is met. In step 102 the bad debt software automatically applies a specific amount from the prepaid account balance towards the bad debt balance. The amount can be based on a percentage or a fixed amount. Either of these methods can be applied to all accounts, all transactions within an account, or selected ones based on the criteria of the service provider using the invention. For instance, a fixed amount can be applied to certain triggering events (e.g. each telephone call made, each data transaction, once a month, etc.), while other triggering events (e.g. recharging the pre-paid balance) would be assessed a percentage of the amount deposited to the pre-paid account.

Step 200 in FIG. 3 occurs when the customer uses a prepaid service of the company. In step 201 the configuration settings in the bad debt software will determine if some of the prepaid balance should be applied towards the bad debt balance, and the flow continues to step 202 if the criteria is met. In step 202 the bad debt software automatically applies a specific amount from the prepaid account balance towards the bad debt balance. The amount can be based on a percentage or a fixed amount.

Step 300 in FIG. 3 occurs at a scheduled time. The schedule could be a monthly interval for a surcharge. In step 301 the configuration settings in the bad debt software will determine if some of the prepaid balance should be applied towards the bad debt balance, and the flow continues to step 302 if the criteria is met. In step 302 the bad debt software automatically applies a specific amount from the prepaid account balance towards the bad debt balance. The amount can be based on a percentage or a fixed amount.

Step 400 in FIG. 3 occurs when the customer recharges his prepaid account balance. The recharge can occur via a customer service representative 16 (FIG. 1), automated telephony interface 13, web interface 18, Point of sales, or other method of recharging. In step 401, the configuration settings in the bad debt software will determine if some of the prepaid balance should be applied towards the bad debt balance, and the flow continues to step 402 if the criteria is met. In step 402 the bad debt software automatically applies a specific amount from the prepaid account balance towards the bad debt balance. The amount can be based on a percentage or a fixed amount.

Having described and illustrated the principles of the invention in a preferred embodiment thereof, it should be apparent that the invention can be modified in arrangement and detail without departing from such principles. We claim all modifications and variation coming within the spirit and scope of the following claims.

What is claimed is:

1. A method for enabling continued use of a paid service by a customer from a service provider comprising the steps of:
accumulating a customer debt balance from past service use into a post-paid debt account and storing said customer debt balance in a bad debt account database;
allowing deposit of pre-paid funds into a pre-paid account associated with the customer and storing a pre-paid account balance of said pre-paid funds in a pre-paid database;
allowing use by the customer of services associated with the pre-paid funds;
withdrawing from the pre-paid balance an amount reflective of the services used by the customer;
detecting a triggering event associated with use by the customer of the pre-paid service, withdrawing an additional amount from the pre-paid balance responsive to the detected triggering event, and applying the additional amount withdrawn to the customer debt balance stored in the bad debt account database; and
reconciling the pre-paid account balance and customer debt balance with the amount withdrawn and additional amount withdrawn responsive to use by the customer of the services associated with the pre-paid funds.

2. The method of claim 1, further including the steps of:
prior to allowing use by the customer of services associated with the pre-paid funds, allowing use by the customer of services associated with post-paid funds;
detecting a post-paid triggering event associated with use by the customer of the post-paid services; and
moving the customer to the pre-paid services responsive to a detection of the post-paid triggering event.

3. The method of claim 2, wherein the post-paid triggering event is taken from the group consisting of late payment by the customer for the services, number of late payments by the customer for the services, credit score of the customer, and payment history of the customer.

4. The method of claim 1, wherein the triggering event occurs when the bad debt account for the customer is established.

5. The method of claim 1, wherein the triggering event occurs when the services associated with the prepaid funds are used by the customer.

6. The method of claim 1, wherein the triggering event occurs periodically on a schedule set in advance by the service provider.

7. The method of claim 1, further including the step of recharging the pre-paid balance with additional funds responsive to a communication from the customer.

8. The method of claim 7, wherein the triggering event occurs when the pre-paid balance is recharged with additional funds.

9. The method of claim 1, wherein the additional amount withdrawn from the pre-paid balance responsive to the detected triggering event is equal to a fixed amount.

10. The method of claim 1, wherein the additional amount withdrawn from the pre-paid balance responsive to the detected triggering event is equal to a percentage of the amount withdrawn from the pre-paid balance reflective of the services used by the customer.

11. The method of claim 1, wherein the pre-paid and post-paid services are taken from the group consisting of telephony services, web services, and utility services.

12. A method for transferring a customer from post-paid to pre-paid services, comprising:
allowing a customer to use services under a post-paid regime, accumulating a customer debt balance, and storing said customer balance in a debt database from such use;
preventing the customer from using the services under the post-paid regime responsive to a debt trigger event;
transferring said customer to a pre-paid regime, accepting pre-paid funds from the customer, storing said pre-paid funds into a pre-paid account, and allowing the customer to use services only under the pre-paid regime so long as the pre-paid account shows a positive balance;
withdrawing funds from the pre-paid account responsive to use under the pre-paid regime; and
withdrawing an additional amount from the pre-paid account and applying the additional amount to the customer debt balance.

13. The method of claim 12, wherein the services are taken from the group consisting of telephony services, web services, and utility services.

14. The method of claim 12, further including:
storing a bad debt balance field within the customer debt balance stored in the debt database; and
populating the bad debt balance field with a monetary value to thereby associate the customer with a bad debt account.

15. The method of claim 12, further including the step of sending an activation notice responsive to the debt trigger event.

16. A bad debt recovery system comprising:
a bad debt application server coupled over a network to at least one service server;
a bad debt database server in communication with the bad debt application server and adapted to store for each bad debt customer account a bad debt balance and a pre-paid balance; and
bad debt software loaded on the bad debt application server operable to detect customer activity and move a customer from a postpaid account to a pre-paid account responsive to trigger criteria detected by the bad debt software, said software also enabled to transfer balances between the pre-paid account balance and the bad debt account balance responsive to activity by the bad debt customer with the pre-paid account.

17. The bad debt recovery system of claim 16, further including:
a post-paid billing system adapted to store a customer account in a post-paid regime;
communication means coupled between said post-paid billing system and said bad debt database server, wherein said bad debt database server is adapted to generate and transmit an activation notice to the post-paid billing system upon transference of a customer from the post-paid regime to a pre-paid regime.

18. The bad debt recovery system of claim 16, wherein the trigger criteria includes late payment by the customer for the services, number of late payments by the customer for the services, credit score of the customer, and payment history of the customer.

19. The bad debt recovery system of claim 16, wherein said bad debt balance is a field stored within a pre-paid customer account balance to designate said pre-paid customer as a bad debt account.

20. The bad debt recovery system of claim 16, wherein said bad debt software includes logic adapted to transfer balances between the pre-paid account balance and the bad debt account balance in an amount equal to a percentage of fees charged to implement the pre-paid service for the customer.
